(19) United States
(12) Patent Application Publication
(10) Pub. No.: US 2003/0027583 A1
(43) Pub. Date: Feb. 6, 2003

(54) Portable terminal device having a position information detection function and position information notifying method

(75) Inventor: Kazuyuki Yugami, Shizuoka (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/199,118

(22) Filed: Jul. 22, 2002

(30) Foreign Application Priority Data
Jul. 31, 2001 (JP) 231027/2001

(51) Int. Cl. H04Q 7/20

(52) U.S. Cl. 455/456; 455/466

(57) ABSTRACT

A mobile terminal device has a function for receiving and transmitting an e-mail message. The current position of the mobile terminal device is output by periodically transmitting the position information of the mobile phone in an e-mail, by use of a timer, which is controlled by the control unit.

### BACKGROUND OF THE INVENTION

1. Field of the Invention

The present invention relates to a portable terminal device. More particularly, the present invention relates to a mobile terminal device having a position information detection function and a method for notifying a base station of the position information.

2. Description of the Related Art

As disclosed in Japanese Laid-open Patent Application 2001-25056, there is a means for recognizing position information of a mobile terminal from the outside.

Referring to FIG. 1, a cell system described in the application comprises a mobile terminal 106, base stations 102, 103, 104, 105, and a switch 100 connected to the base stations. The cell system further comprises a means for storing position information of the mobile terminal 106 with a registering time in a storage device 101. The cell system further comprises a means for outputting the position information of the mobile terminal 106 to an external device 108 via a predetermined interface 107 connected to the switch 100. The position information of the mobile terminal 106 is outputted from the storage device 101. For example, if the mobile terminal 106 is communicating to the base station 104, the switch 100 outputs, to an external device 108, information from the base station 104 used upon position registration, transmission, reception or the communication with the mobile terminal 106. A call is sent to the mobile phone 106 without causing the mobile terminal 106 to ring, based on a request of the external device 108. The position of the mobile phone 106 is then outputted back to the external device 108 through the base station and switch 100. When the mobile terminal 106 is located out of the call area 109, 110 when the call is sent, the position information stored in the storage device 101 is outputted to the external device 108, together with the registering time.

However, a call needs to be sent to the mobile terminal 106 without causing the mobile terminal 106 to ring, so as to obtain position information at an arbitrary time, and to output the obtained position information to the external device 108. Thus, extra equipment and extensive operations are necessary.

### SUMMARY OF THE INVENTION

The present invention is devised in view of the above-described problem. It is an aspect of the invention to provide a portable terminal device capable of detecting its position and notifying other devices of its location without requiring an operation from the user.

To solve the above mentioned problem, a mobile terminal device of the present invention comprises a communicating means for communicating in electronic mail messages (hereinafter “e-mail”), and a measuring means for measuring a current position of the mobile terminal device by using a GPS. The mobile terminal device further comprises a storing means for storing information related to the current position and a transmitting means for transmitting the position information in an e-mail message. The measuring means measures the current position at a predetermined interval, and the measurement can be made using a GPS system. The user of the mobile terminal device can set the predetermined interval. The mobile terminal device of the present invention further comprises setting means for setting a flag that indicates whether the transmitting means should be operated. And then, the mobile terminal device comprises comparing means for comparing the current position information with previously stored position information, and outputting a result. The mobile terminal device further comprises controlling means for controlling the transmitting means based on the result of the comparing means. The controlling means controls the transmitting means to transmit the current position information if the current position information is different from previously stored position information. On the other hand, the controlling means controls the transmitting means to not to transmit the current position information if the current position information is the same as the previously stored position information.

Further, a mobile terminal device of the present invention comprises a communication circuit that communicates using e-mail messages, and a measuring circuit that measures a current position of the mobile terminal device. The mobile terminal device further comprises a memory that stores information related to the current position and transmitter that transmits the position information in an e-mail message. The measuring circuit measures the current position at a predetermined interval and the position can measured using a GPS system. The user of the mobile terminal device can set the predetermined interval. The mobile terminal device of the present invention may comprise a setting circuit that sets a flag that indicates whether the transmitter should be operated. Furthermore, the mobile terminal device of the present invention comprises a comparator that compares the current position information with previously stored position information and outputs a result, and controller that controls the transmitter based on the result of the comparator. The controller controls the transmitter to transmit the current position information if the current position information is different from the previously stored position information. On the other hand, the controller commands the transmitter not to transmit the current position information if the current position information is the same as the previously stored position information.

In another aspect of the present invention, a position information notification method for a portable terminal device comprises measuring a current position, storing information related to the current position and transmitting the position information in an e-mail message. The current position is measured at a predetermined interval, and a GPS system can be used. The method further comprises setting at least one of the predetermined interval and a flag that indicates whether the transmitting of the position information in an e-mail message should be operated. The method further comprises comparing the current position information with previously stored position information and controlling the transmission of the e-mail message with the position information based on the result of the comparison. The method further comprises transmitting the current position information if the current position information is different from the previously stored position information. Alternatively, the current position information will not be transmitted if the current position information is the same as the previously stored position information.

According to the present invention, position information of a mobile phone device can be obtained without user intervention. Further, in the present invention, a moving route of the mobile phone can be known because the position information is periodically notified. Furthermore, a base station and a switch for notifying the position information are not necessary because all the position information is notified by the mobile phone.

### BRIEF DESCRIPTION OF THE DRAWINGS

These and other aspects, features and advantages of the invention will become more fully apparent from the following detailed description taken in conjunction with accompanying drawings. In the drawings:

FIG. 1 is a block diagram showing a related art position search system for a mobile terminal;

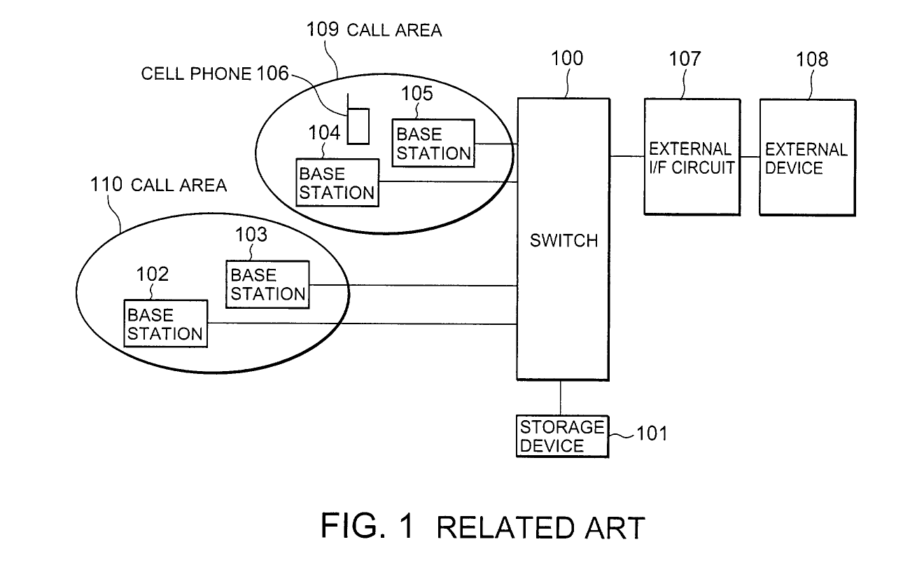

FIG. 2 is a block diagram showing an exemplary structure of a mobile terminal device according to an embodiment of the present invention; and

FIG. 3 is a flowchart showing the operation of the mobile terminal device according to an embodiment of the present invention.

### DETAILED DESCRIPTION OF THE EMBODIMENTS

Hereinafter, each embodiment of the present invention will be described in detail with reference to the drawings.

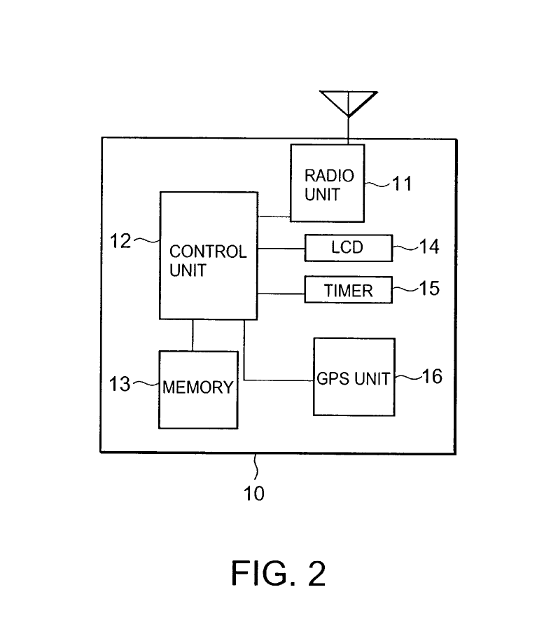

FIG. 2 is a block diagram showing the structure of a mobile terminal device according to the embodiment of the present invention.

Referring to FIG. 2, a mobile terminal device 10 has an electronic mail message function (hereinafter referred to as “e-mail”) and a GPS function. The mobile terminal device 10 comprises a radio unit 11 for receiving and transmitting data, a control unit 12, a memory 13, an LCD 14 for displaying information, a timer 15, and a GPS unit 16.

The control unit 12 controls the transmission and the reception of messages through the radio unit 11. The control unit also sets the time interval between position updates. The control unit further controls the LCD 14, the timer 15 and the GPS unit 16. The memory 13 stores at least the address data for the e-mail messages, position information, the setting of ON/OFF of the notification of the position information, and the setting of a notifying interval between position updates.

In FIG. 2, the user of the mobile terminal device 10 sets the ON/OFF in the memory 13 for the notification of position information. When the ON setting of the notification of the position information is set in the memory 13 in the mobile terminal device 10, the timer 15 sends an interrupt to the control unit 12 at a notifying interval T. The notifying interval T is stored in the memory 13 by the user.

When the control unit 12 receives the interrupt at the notifying interval T, the GPS unit 16 measures the current position of the mobile terminal device 10, and reads the current position information. Further, the control unit 12 transmits the read data of the current position information as an e-mail message to an e-mail address, which is stored in the memory 13 in advance. The control unit 12 transmits the e-mail message via the radio unit 11.

The control unit 12 stores the position information transmitted in the e-mail message to the memory 13. If the position information has not changed at the next notifying interval T, the control unit 12 cancels the transmission of the e-mail message in order to save power. On the other hand, if the control unit 12 detects that the position information has changed, the updated position information is transmitted in an e-mail message.

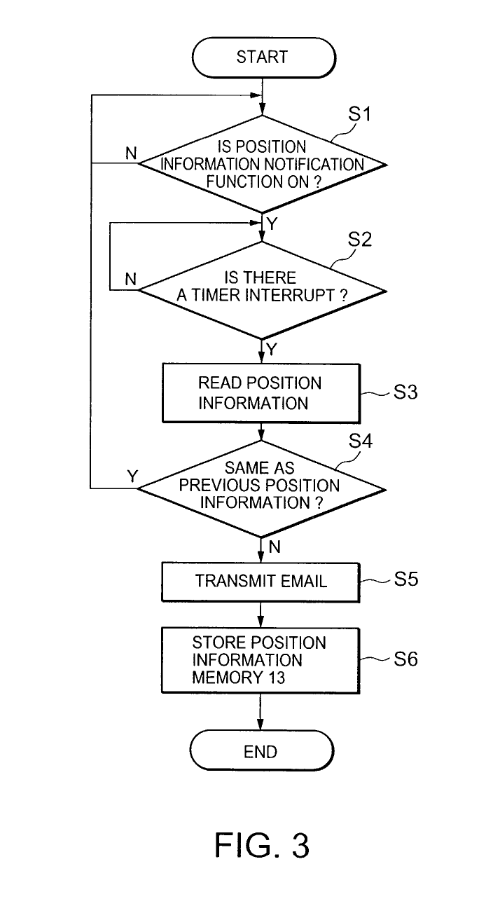

FIG. 3 is a flowchart showing the operation of the mobile terminal device 10 in FIG. 2.

Referring to FIG. 3, at S1, a determination is made if the position information notification function of the mobile terminal device 10 is set to ON. The user has not set the position information notification function to ON, then S1 is repeated until the position information notification function is set to ON. At S2, if the notification function is ON, the control unit 12 waits until it detects the interrupt of the timer 15. The timer interrupt is generated at a predetermined notifying interval T(e.g., at an interval of 1 to 60 min). At S3, after receiving the interrupt from the timer 15, the control unit 12 reads the data of the position information from the GPS unit 16.

At S4, the control unit 12 compares the position information data read in S3 with the previous measured data, which is stored in the memory 13. If the current position information data is the same as the previous measured data, the control unit 12 starts the operation again from S1. However, if the current position information data is different from the previous measured data, at S5, the current position information is transmitted to the e-mail address that is stored in advance to the memory 13. After transmitting the e-mail message containing the current position information, at S6, the current position information is stored in the memory 13.

Obviously, numerous additional modifications and variations of the present invention are possible in light of the above teachings. It is, therefore, to be understood that within the scope of the appended claims, the invention may be practiced otherwise than as specifically described herein.

What is claimed is:

1. A mobile terminal device comprising:
communicating means for communicating an e-mail message;
measuring means for measuring a current position of said mobile terminal device;
storing means for storing information related to said current position; and
transmitting means for transmitting said information related to said current position in an e-mail message.

2. The mobile terminal device as claimed in claim 1, wherein said measuring means measures said current position at a predetermined interval.

3. The mobile terminal device as claimed in claim 1, wherein said measuring means comprises a GPS system.

4. The mobile terminal device as claimed in claim 2, wherein a user of said mobile terminal device can set said predetermined interval.

5. The mobile terminal device as claimed in claim 4, further comprising a timing means that outputs a timing signal based upon wherein said predetermined interval.

6. The mobile terminal device as claimed in claim 1, wherein said storage means stores a predefined e-mail address for said e-mail message.

7. The mobile terminal device as claimed in claim 2, further comprising setting means for setting a flag indicating whether said transmitting means should be operated.

8. The mobile terminal device as claimed in claim 7, further comprising:
comparing means for comparing said information related to said current position with previously stored position information of said mobile terminal device, and outputting a result; and
controlling means for controlling said transmitting means based on the result output from said comparing means.

9. The mobile terminal device as claimed in claim 8, wherein said controlling means controls said transmitting means to transmit said information related to said current position if said information related to said current position is different from said previously stored position information of said mobile terminal device.

10. The mobile terminal device as claimed in claim 8, wherein said controlling means controls said transmitting means not to transmit said information related to said current position if said information related to said current position is the same as said previously stored position information of said mobile terminal device.

11. A mobile terminal device comprising:
a communications circuit that communicates with e-mail messages;
a measuring circuit that measures a current position of said mobile terminal device;
a memory that stores information related to said current position; and
a transmitter that transmits said information related to said current position in an e-mail message.

12. The mobile terminal device as claimed in claim 11, wherein said measuring circuit measures said current position at a predetermined interval.

13. The mobile terminal device as claimed in claim 11, wherein said measuring means comprises a GPS system.

14. The mobile terminal device as claimed in claim 13, wherein a user of said mobile terminal device can set said predetermined interval.

15. The mobile terminal device as claimed in claim 12, further comprising a timing means that outputs a timing signal based upon wherein said predetermined interval.

16. The mobile terminal device as claimed in claim 11, wherein said storage means stores a predefined e-mail address for said e-mail message.

17. The mobile terminal device as claimed in claim 11, further comprising a setting circuit that sets a flag indicating whether said transmitter should be operated.

18. The mobile terminal device as claimed in claim 17, further comprising:
a comparator that compares said information related to said current position with previously stored position information of said mobile terminal device, and outputting a result; and
a controller that controls said transmitter based on the result output from said comparator.

19. The mobile terminal device as claimed in claim 18, wherein said controller controls said transmitter to transmit said information related to said current position if said information related to said current position is different from said previously stored position information of said mobile terminal device.

20. The mobile terminal device as claimed in claim 18, wherein said controller controls said transmitter not to transmit said information related to said current position if said information related to said current position is the same as said previously stored position information of said mobile terminal device.

21. A method for outputting position information of a portable terminal device, comprising:
measuring a current position of said portable terminal device;
storing information related to said current position of said portable terminal device; and
transmitting said information in an e-mail message to a predetermined address.

22. The method for outputting position information as claimed in claim 21, wherein said measuring a current position of said portable terminal device measures said current position at a predetermined interval.

23. The method for outputting position information as claimed in claim 22, further comprising setting at least one of said predetermined interval and a flag to indicate if transmitting said information in an e-mail message should be operated.

24. The method for outputting position information as claimed in claim 23, further comprising:
comparing said current position information with previously stored information of said mobile terminal device, and outputting a result; and
controlling said transmitting means based on the result of said comparison.

25. The method for outputting position information as claimed in claim 24, further comprising transmitting said current position information if said current position information is different from said previously stored information of said mobile terminal device.

26. The method for outputting position information as claimed in claim 24, wherein said controlling said transmitting means does not to transmit said current position information if said current position information is the same as said previously stored information of said mobile terminal device.
